(19) United States
(12) Patent Application Publication
(10) Pub. No.: US 2017/0291394 A1
(43) Pub. Date: Oct. 12, 2017

(54) COMPOSITE ARTICLE OF INORGANIC NON-METAL AND RESIN AND METHOD FOR MAKING THE SAME

(71) Applicants: Ur Materials Industry (ShenZhen) Co., Ltd., Shenzhen (CN); HON HAI PRECISION INDUSTRY CO., LTD., New Taipei (TW)

(72) Inventors: HSIN-PEI CHANG, New Taipei (TW); WEN-RONG CHEN, New Taipei (TW); HUANN-WU CHIANG, New Taipei (TW); PING CHANG, New Taipei (TW); YUNG-CHING HUANG, New Taipei (TW); JUAN ZHANG, Shenzhen (CN); YANG-JIA LIU, Shenzhen (CN)

(21) Appl. No.: 15/391,797

(22) Filed: Dec. 27, 2016

(30) Foreign Application Priority Data
Apr. 8, 2016 (CN) 201610220541.4

(51) Int. Cl. B32B 7/04; B29C 45/14; C03C 15/00; C03C 23/00; B32B 3/30; B32B 17/06

(52) U.S. Cl. CPC B32B 7/04; B32B 3/30; B32B 17/064; C03C 15/00; C03C 23/0025; B29C 45/14336; B29C 45/14795; B32B 2250/02; B32B 2307/542; B32B 2307/536; B32B 2457/00; B29K 2101/12

(57) ABSTRACT

A composite article includes an inorganic non-metallic article and a resin article. The resin article is connected to the inorganic non-metallic article. The inorganic non-metallic article includes at least one connecting surface. At least a portion of the connecting surface comprises groove-peak like microstructures. At least one of the microstructures comprises a rough and/or porous surface having at least one of a roughness element and a porous structure. The inorganic non-metallic article and resin article are combined together through the microstructures. A method for making the composite article is also provided.

### FIELD

The subject matter generally relates to a composite article of inorganic non-metal and resin, and a method for making the composite article of inorganic non-metal and resin.

### BACKGROUND

Hard inorganic non-metallic materials, such as glass, ceramic, and sapphire, are widely used in housings of electronic products. To have a beautiful appearance or some special functions such as preventing signal from being shielded, the housing of electronic product usually is assembled by connecting two or more components made of different inorganic non-metallic materials. However, inorganic non-metallic material usually has poor toughness and poor ductility, making it difficult to connect two inorganic non-metallic articles together without using adhesive material or bonding agent. However, conventional adhesive material and bonding agents yield poor bonding strength, such as shear strength, when being used to connect two inorganic non-metallic articles. It is desirable for an inorganic non-metallic article to be connected to a resin article first to form a composite article, and then the composite article can be connected to other components through the resin article.

### BRIEF DESCRIPTION OF THE DRAWINGS

Implementations of the present technology will now be described, by way of example only, with reference to the attached figures.

FIG. 1 is a cross-sectional view of an exemplary embodiment of a portion of a composite article of inorganic non-metal and resin.

FIG. 2 is a flowchart of a method for making a composite article of inorganic non-metal and resin.

FIG. 3 is a cross-sectional view of an inorganic non-metallic article with microstructures.

FIG. 4 is a scanning electron microscope (SEM) image of a connecting surface of an inorganic non-metallic article having microstructures.

FIG. 5 is a cross-sectional view of an inorganic non-metallic article having microstructures with rough and/or porous surfaces.

FIG. 6 is an SEM image of an inorganic non-metallic article having microstructures with rough and/or porous surfaces.

FIG. 7 is a cross-sectional view of an injection molding apparatus for forming a composite article of inorganic non-metal and resin.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the exemplary embodiments described herein. However, it will be understood by those of ordinary skill in the art that the exemplary embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

The term “comprising” when utilized, means “including, but not necessarily limited to”; it specifically indicates open-ended inclusion or membership in the so-described combination, group, series, and the like.

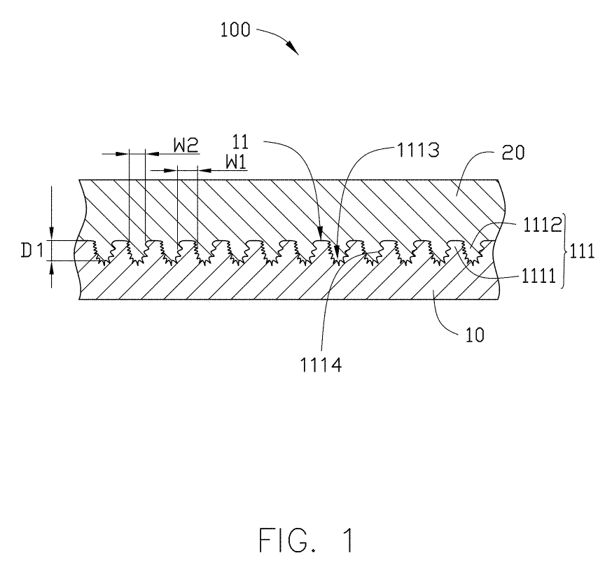

FIG. 1 illustrates an exemplary embodiment of a portion of a composite article 100 of inorganic non-metal and resin (hereinafter “composite article 100”). The composite article 100 includes an inorganic non-metallic article 10 and a resin article 20 connected to the inorganic non-metallic article 10. The composite article 100 may be a housing of an electronic product. The composite article 100 may also be a building component, a medical device, or a car body or component.

The inorganic non-metallic article 10 includes at least one connecting surface 11 configured to connect the inorganic non-metallic article 10 and resin article 20. At least a part of the connecting surface 11 includes groove-and-peak microstructures 111. The microstructures 111 include a plurality of peaks 1111 and a plurality of grooves 1112 on the connecting surface 11. A portion of the resin article 20 fills in the grooves 1112. The microstructures 111 can increase the contact area between the resin article 20 and the inorganic non-metallic article 10, and form a strong mechanical connection between the resin article 20 and the inorganic non-metallic article 10 through the microstructures 111, thereby improving the bonding strength between the resin article 20 and the inorganic non-metallic article 10.

In at least one exemplary embodiment, the width W1 of each peak 1111 is in a range from about 10 nm to about 50 μm. The width W2 of each groove 1112 is in a range from about 10 nm to about 50 μm. The depth D1 of each groove 1112 is in a range from about 10 nm to about 100 μm.

The microstructures 111 each include a rough and/or porous surface 1113 for receiving resin article 20. A portion of the resin article 20 fills in the rough and/or porous surface 1113 of each of the microstructures 111. The rough and/or porous surface 1113 can further increase the contact area between the resin article 20 and the inorganic non-metallic article 10, and result in forming a strong mechanical grip between the resin article 20 and the inorganic non-metallic article 10, thereby improving the bonding strength between the resin article 20 and the inorganic non-metallic article 10.

The rough and/or porous surface 1113 may include roughness elements 1114 and/or porous structures. When the rough and/or porous surface 1113 of the microstructures 111 include the roughness elements 1114, the surface roughness of the rough and/or porous surface 1113 has a range from about 3 nm to about 500 nm. When the rough and/or porous surface 1113 of the microstructures 111 include the porous structures, the porous structures may include diameters in a range from about 2 nm to about 100 nm.

The inorganic non-metallic article 10 is made of a hard inorganic non-metallic material. The hard inorganic non-metallic material may be glass, ceramics, or sapphire.

In one exemplary implementation, the resin article 20 may include crystalline thermoplastic with a high fluidity, such as exemplified by polyphenylenesulfide (PPS), polyamide (PA), polybutylene terephthalate (PBT), polycarbonate (PC), or polyethylene terephthalate (PET).

In another exemplary implementation, the resin article 20 may include glass fibers or carbon fibers. The glass fibers and carbon fibers can improve shock and heat resistance of the resin article 20. As the shock and heat resistance are improved, the resin article 20 can resist significant shrinking, tiling, or peeling from the inorganic non-metallic article 10.

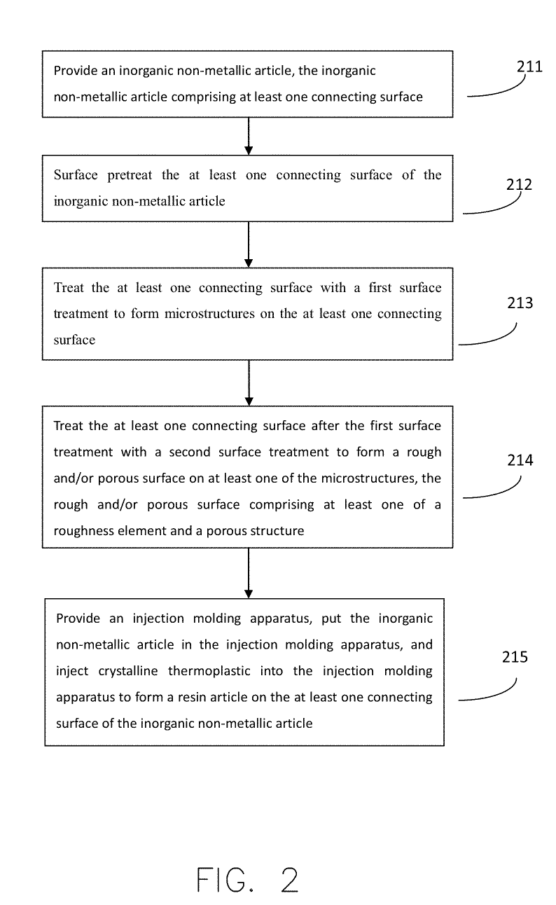

FIG. 2 is a flowchart of an exemplary method for making the composite article of inorganic non-metal and resin 100. The exemplary method is provided by way of example, as there are a variety of ways to carry out the method. The method can be carried out as illustrated in FIG. 2, for example. Each block shown in FIG. 2 represents one or more processes, methods, or subroutines carried out in the example method. Furthermore, the illustrated order of blocks is illustrative only and the order of the blocks can change. Additional blocks can be added or fewer blocks may be utilized without departing from this disclosure. The exemplary method can begin at block 211.

At block 211, an inorganic non-metallic article 10 is provided. The inorganic non-metallic article 10 is made of glass, ceramics, or sapphire. The inorganic non-metallic article 10 includes at least one connecting surface 11.

At block 212, the connecting surface 11 of the inorganic non-metallic article 10 is pretreated by a surface pretreatment. The surface pretreatment can remove oil, fat, and grease on the connecting surface 11.

The surface pretreatment can be carried out by the following steps: (1) putting the inorganic non-metallic article 10 into an ultrasonic cleaner (not shown) with a cleaning agent; (2) ultrasonically cleaning the inorganic non-metallic article 10 for about 2 minutes to about 10 minutes. The cleaning agent is alcohol or acetone.

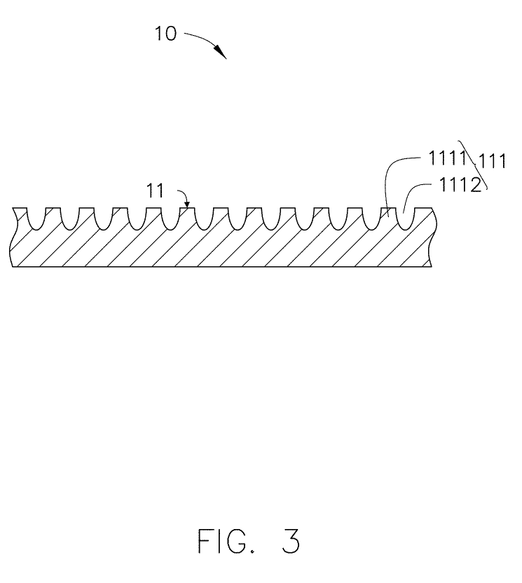

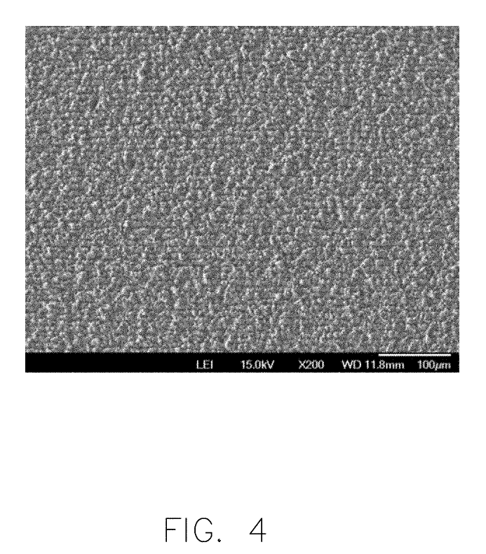

At block 213, referring to FIGS. 3-4, the connecting surface 11 after the surface pretreatment is treated by a first surface treatment to form a plurality of microstructures 111 on the connecting surface 11.

The first surface treatment is a surface roughening treatment or a surface pore-forming treatment. The surface roughening treatment or surface pore-forming treatment may include chemical etching, exposure and development, electrochemical etching, or laser etching.

In at least one exemplary embodiment, the first surface treatment is chemical etching or exposure and development may include: (1) covering an surface portion of the inorganic non-metallic article 10 that is not to be etched by photosensitive ink or photoresist, thereby forming a masked area and an exposed area; (2) etching the exposed area of the inorganic non-metallic article 10 by a corrosive liquid for about 5 minutes to about 15 minutes; (3) heat treating the inorganic non-metallic article 10 for about 10 minutes to about 20 minutes, and when being heat treated, the temperature of the article 10 is in a range from about 100 to about 180; and (4) removing the photosensitive ink or photoresist.

The corrosive liquid may include hydrofluoric acid, hydrofluoric acid ammonium, hydrogen nitrate, phosphoric acid, hydrochloric acid, oxalic acid, ammonia sulfate, glycerol, barium sulfate, ammonia fluoride, sal mirabile, ammonium hydrogen fluoride, ammonium fluoride, calcium fluoride, sodium fluoborate, potassium borofluoride, magnesium borate, starch, or sodium fluoride.

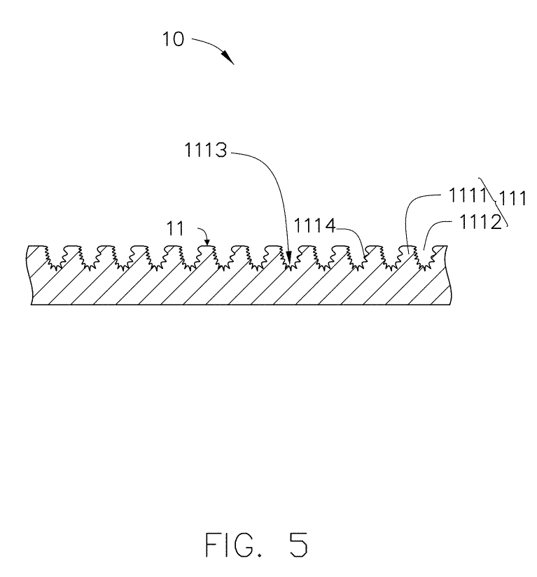

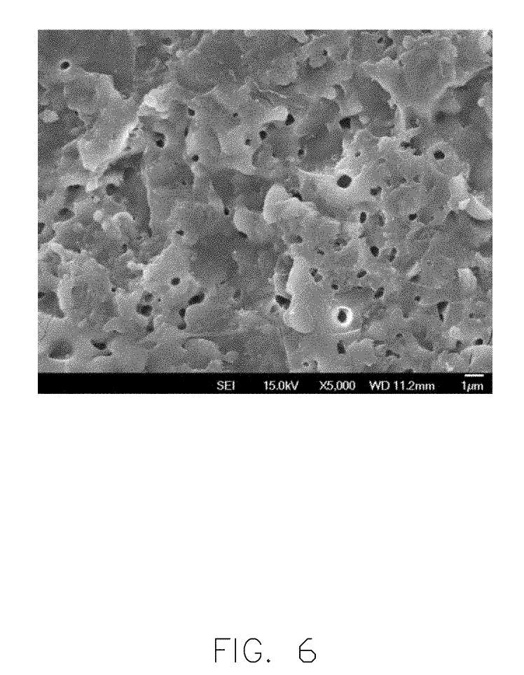

At block 214, referring to FIGS. 5-6, the inorganic non-metallic article 10 after the first surface treatment is treated by a second surface treatment to form a rough and/or porous surface 1113 on the microstructures 111.

The second surface treatment is a surface roughening treatment or a surface pore-forming treatment. The surface roughening treatment or the surface pore-forming treatment may include chemical etching, exposure and development, electrochemical etching, or laser etching.

In at least one exemplary embodiment, the second surface treatment is chemical etching which can be carried out by the following steps: (1) covering an surface portion of the connecting surface 11 that is not to be etched by photosensitive ink or photoresist thereby forming a masked area and an exposed area; (2) etching the exposed area of the connecting surface 11 by an etchant for a period of time; (3) ultrasonically treating the connecting surface 11 for about 30 minutes, and when being ultrasonically treated, the inorganic non-metallic article 10 has a temperature of about 60 to about 70; (4) removing the photosensitive ink or photoresist.

The etchant may include sodium hydroxide, sal perlatum, sodium phosphate, or ethylenediaminetetraacetic acid disodium salt.

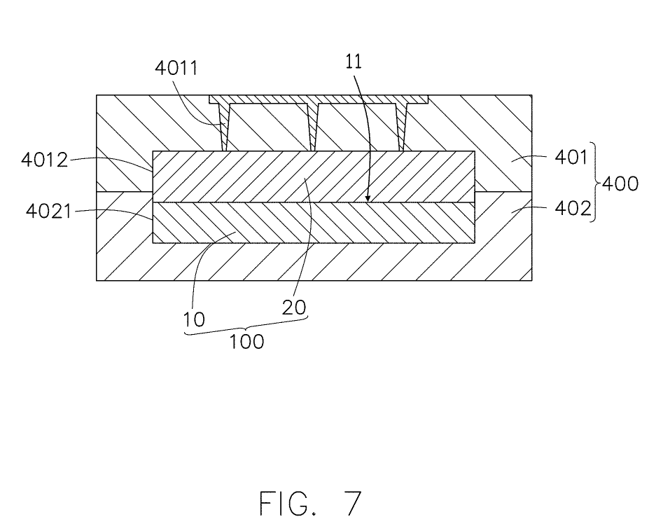

At block 215, referring to FIG. 7, the inorganic non-metallic article 10 after the second surface treatment is placed in an injection molding apparatus 400. A resin article 20 is formed on the connecting surface 11 of the inorganic non-metallic article 10 by injection molding, thereby obtaining the composite article 100.

The injection molding apparatus 400 includes a top mold 401 and a bottom mold 402. The top mold 401 includes a plurality of sprue gates 4011 and a first cavity 4012. The first cavity 4012 is configured to form the resin article 20. The bottom mold 402 includes a second cavity 4021. The second mold 4021 is configured to receive the inorganic non-metallic article 10. The inorganic non-metallic article 10 is placed into the second cavity 4021, and the top mold 401 covers the bottom mold 402. Then, crystalline thermoplastic is injected into the first cavity 4012 through the sprue gates 4011. The crystalline thermoplastic solidifies to form the resin article 20. Although the connecting surface 11 of the inorganic non-metallic articleb 10 in FIG. 7 appears to be substantially planar, it should be understood that groove-and-peak microstructures 111 are formed on the connecting surface 11, where the plurality of peaks 1111 and the plurality of grooves 1112 of the microstructures 111 each include a rough and/or porous surface 1113, as shown in FIG. 1.

### Example 1

An inorganic non-metallic article 10 was provided. The inorganic non-metallic article 10 was made of glass. The inorganic non-metallic article 10 included a connecting surface 11.

The inorganic non-metallic article 10 was put into an ultrasonic cleaner with alcohol and cleaned ultrasonically.

The connecting surface 11 of the inorganic non-metallic article 10 was treated by laser etching to form microstructures 111. The microstructures 111 included a plurality of peaks 1111 and a plurality of grooves 1112 on the connecting surface 11. The width of each groove 1112 was in a range from about 10 nm to about 20 μm. The depth of each groove 1112 was in a range from about 1 μm to about 100 μm.

The surface portion of the inorganic non-metallic article 10 not to be etched was covered by photosensitive ink. The inorganic non-metallic article 10 was put into a sodium hydroxide solution having a mass concentration of 20%, and ultrasonically treatment of the inorganic non-metallic article 10 was carried out for 30 minutes at a temperature of 70, thereby forming the rough and/or porous surface 1113 on the microstructures 111. The photosensitive ink was then removed.

An injection molding apparatus 400 was provided, the inorganic non-metallic article 10 was put into the first cavity 4012. Crystalline thermoplastic was injected into the second cavity 4021 through sprue gates 4011, then the crystalline thermoplastic was solidified to form a resin article 20 on the connecting surface 11, thereby forming a composite article 100.

### Example 2

An inorganic non-metallic article 10 was provided. The inorganic non-metallic article 10 was made of glass. The inorganic non-metallic article 10 included a connecting surface 11.

The inorganic non-metallic article 10 was put into an ultrasonic cleaner with alcohol and cleaned ultrasonically.

The surface portion of the inorganic non-metallic article 10 not to be etched was covered by photosensitive ink. The surface portion of the inorganic non-metallic article 10 to be etched was chemical etched by a corrosive liquid for 10 minutes, to form the microstructures 111 on the connecting surface 11. The corrosive liquid was a mixture of hydrofluoric acid, hydrogen nitrate, and water. The hydrofluoric acid had a volume percent of 20% of the total volume of the etchant; the hydrogen nitrate had a volume percent of 14% of total volume of the etchant; and the water had a volume percent of 66% of total volume of the etchant.

The surface portion of the inorganic non-metallic article 10 not to be etched was covered by photosensitive ink. The inorganic non-metallic article 10 was put into a sodium hydroxide solution having a mass concentration of 20%, and ultrasonically treatment of the inorganic non-metallic article 10 was carried out for 30 minutes at a temperature of 70, thereby forming the rough and/or porous surface 1113 on each of the microstructures 111. The photosensitive ink was removed.

An injection molding apparatus 400 was provided, the inorganic non-metallic article 10 was put into the first cavity 4012. Crystalline thermoplastic was injected into the second cavity 4021 through sprue gates 4011, then the crystalline thermoplastic was solidified to form a resin article 20 on the connecting surface 11 of the inorganic non-metallic article 10, thereby forming a composite article 100.

### EXAMPLE 3

An inorganic non-metallic article 10 was provided. The inorganic non-metallic article 10 was made of glass. The inorganic non-metallic article 10 included a connecting surface 11.

The inorganic non-metallic article 10 was put into an ultrasonic cleaner with alcohol and cleaned ultrasonically.

The surface portion of the inorganic non-metallic article 10 not to be etched was covered by photosensitive ink. The surface portion of the inorganic non-metallic article 10 to be etched was chemical etched by a corrosive liquid for 10 minutes, to form the microstructures 111 on the connecting surface 11. The corrosive liquid was a mixture of ammonia fluoride, phosphoric acid, and water. The corrosive liquid includes 180 grams of ammonia fluoride, 30 grams of phosphoric acid, and 90 grams of water.

The surface portion of the inorganic non-metallic article 10 not to be etched was covered by photosensitive ink. The inorganic non-metallic article 10 was put into a sodium hydroxide solution having a mass concentration of 20%, and an ultrasonically treatment of the inorganic non-metallic article 10 was carried out for 30 minutes at a temperature of 70, thereby forming the rough and/or porous surface 1113 on the microstructures 111. The photosensitive ink was then removed.

An injection molding apparatus 400 was provided, the inorganic non-metallic article 10 was put into the first cavity 4012. Crystalline thermoplastic was injected into the second cavity 4021 through sprue gates 4011, then the crystalline thermoplastic was solidified to form a resin article 20 on the connecting surface 11 of the inorganic non-metallic article 10, thereby forming a composite article 100.

### Example 4

An inorganic non-metallic article 10 was provided. The inorganic non-metallic article 10 was made of glass. The inorganic non-metallic article 10 included a connecting surface 11.

The inorganic non-metallic article 10 was put into an ultrasonic cleaner with alcohol and cleaned ultrasonically.

The surface portion of the inorganic non-metallic article 10 not to be etched was covered by photosensitive ink. The surface portion of the inorganic non-metallic article 10 to be etched was chemical etched by a corrosive liquid for 10 minutes, to form the microstructures 111 on the connecting surface 11. The corrosive liquid was a mixture of ammonia fluoride, oxalic acid, ammonia sulfate, sal mirabile, glycerol, and water. The corrosive liquid includes 15 grams of ammonia fluoride, 7 grams of oxalic acid, 8 grams of ammonia sulfate, 14 grams of sal mirabile, 35 grams of glycerol, and 10 grams of water.

The surface portion of the inorganic non-metallic article 10 not to be etched was covered by photosensitive ink. The inorganic non-metallic article 10 was put into a sodium hydroxide solution having a mass concentration of 20%, and ultrasonically treated for 30 minutes at a temperature of 70, thereby forming the rough and/or porous surface 1113 on the microstructures 111. The photosensitive ink was removed.

An injection molding apparatus 400 was provided, the inorganic non-metallic article 10 was put into the first cavity 4012. Crystalline thermoplastic was injected into the second cavity 4021 through sprue gates 4011, then the crystalline thermoplastic was solidified to form a resin article 20 on the connecting surface 11 of the inorganic non-metallic article 10, thereby forming a composite article 100.

The composite articles 100 of the examples 1˜4 and a conventional composite article made by gluing the inorganic non-metallic article and the resin article together were tested for shear strength. The test results are showed in the table 1.

TABLE 1
shear strength of the composite articles

| | | | | | Conventional |
|---|---|---|---|---|---|
| | | | | | composite |
| | Example 1 | Example 2 | Example 3 | Example 4 | article |
| Shear | 19.8 Mpa | 18.6 Mpa | 18.9 Mpa | 19.2 Mpa | 5~10 Mpa |
| strength | | | | | |

The test results showed that, comparing to the shear strengths of the conventional composite article, the shear strengths of the composite articles 100 of the examples 1˜4 are improved.

The exemplary embodiments shown and described above are only examples. Even though numerous characteristics and advantages of the present technology have been set forth in the foregoing description, together with details of the structures and function of the present disclosure, the disclosure is illustrative only, and changes can be made in the detail, including in matters of shape, size, and arrangement of the parts within the principles of the present disclosure, up to and including the full extent established by the broad general meaning of the terms used in the claims.

1. A composite article comprising:
an inorganic non-metallic article having at least one connecting surface; and
a resin article connected to the at least one connecting surface of the inorganic non-metallic article;
wherein at least a portion of the at least one connecting surface comprises microstructures, the microstructures include a plurality of peaks and a plurality of grooves on the at least one connecting surface, at least one of the microstructures comprises a rough and/or porous surface having at least one of a roughness element and a porous structure, the inorganic non-metallic article and resin article are connected to each other through the microstructures.

2. The composite article of claim 1, wherein a portion of the resin article fills in the rough and/or porous surface.

3. The composite article of claim 1, wherein the inorganic non-metallic article is made of hard inorganic non-metallic material.

4. The composite article of claim 3, wherein the hard inorganic non-metallic material is selected from a group consisting of glass, ceramics, and sapphire.

5. The composite article of claim 1, wherein the resin article is made of crystalline thermoplastic with a high fluidity.

6. The composite article of claim 5, wherein the crystalline thermoplastic is polyphenylenesulfide, polyamide, polybutylene terephthalate, polycarbonate, or polyethylene terephthalate.

7. The composite article of claim 1, wherein the resin article comprises glass fibers or carbon fibers.

8. The composite article of claim 1, wherein when the rough and/or porous surface of the microstructures include the roughness elements, the surface roughness of the rough and/or porous surface has a range from about 3 nm to about 500 nm.

9. The composite article of claim 1, wherein when the rough and/or porous surface of the microstructures include the porous structures, the porous structures include diameters in a range from about 2 nm to about 100 nm.

10. The composite article of claim 1, wherein the plurality peaks each have a width in a range from about 10 nm to about 50 μm, the plurality of grooves each have a width in a range from about 10 nm to about 50 μm, and the plurality of grooves each have a depth in a range from about 10 nm to about 100 μm.

11. A method for making a composite article comprising:
providing an inorganic non-metallic article, the inorganic non-metallic article comprising at least one connecting surface;
treating the at least one connecting surface with a first surface treatment to form microstructures on the at least one connecting surface;
treating the connecting surface after the first surface treatment with a second surface treatment to form a rough and/or porous surface on at least one of the microstructures, the rough and/or porous surface comprising at least one of a roughness element and a porous structure;
providing an injection molding apparatus, putting the inorganic non-metallic article in the injection molding apparatus, and injecting crystalline thermoplastic into the injection molding apparatus to form a resin article on the connecting surface of the inorganic non-metallic article.

12. The method of claim 11, wherein the inorganic non-metallic article is selected from a group consisting of glass, ceramics, and sapphire.

13. The method of claim 11 further comprises surface pretreating the inorganic non-metallic article to remove oil, fat, and grease before the first surface treatment.

14. The method of claim 11, wherein at least one of the first surface treatment and the second surface treatment is a surface roughening treatment or a surface pore-forming treatment.

15. The method of claim 14, wherein the surface roughening treatment or the surface pore-forming treatment comprises chemical etching, exposure and development, electrochemical etching or laser etching.

16. The method of claim 11, wherein the crystalline thermoplastic comprises polyphenylenesulfide, polyamide, polybutylene terephthalate, polycarbonate or polyethylene terephthalate.

17. The method of claim 11, wherein the crystalline thermoplastic comprises glass fibers or carbon fibers.

18. The method of claim 11, wherein the microstructures comprise a plurality of peaks and a plurality of grooves on the at least one connecting surface.

19. The method of claim 18, wherein the plurality peaks each have a width in a range from about 10 nm to about 50 μm, the plurality of grooves each have a width in a range from about 10 nm to about 50 μm, and the plurality of grooves each have a depth in a range from about 10 nm to about 100 μm.

20. The method of claim 11, wherein a portion of the resin article fills in the rough and/or porous surface.
